(19) United States
(12) Patent Application Publication
(10) Pub. No.: US 2014/0067368 A1
(43) Pub. Date: Mar. 6, 2014

(54) DETERMINING SYNONYM-ANTONYM POLARITY IN TERM VECTORS

(71) Applicants: Wen-tau Yih, Redmond, WA (US); Geoffrey G. Zweig, Sammamish, WA (US); John C. Platt, Bellevue, WA (US)

(72) Inventors: Wen-tau Yih, Redmond, WA (US); Geoffrey G. Zweig, Sammamish, WA (US); John C. Platt, Bellevue, WA (US)

(73) Assignee: Microsoft Corporation, Redmond, WA (US)

(21) Appl. No.: 13/597,277

(22) Filed: Aug. 29, 2012

(51) Int. Cl. G06F 17/27

(52) U.S. Cl. 704/9

(57) ABSTRACT

A document-term matrix may be generated based on a corpus. A term representation matrix may be generated based on modifying a plurality of elements of the document-term matrix based on antonym information included in the corpus. Similarities may be determined based on a plurality of elements of the term representation matrix.

### BACKGROUND

Communication based on terminology is a common task in everyday life. A person may express his/her thoughts or needs via terminology that is familiar to the speaker or writer. However, various terms that the speaker or writer may use may be unfamiliar to a recipient of the communication. Further, the speaker or writer may wish to determine synonyms or antonyms to clarify their discourse. As another example, a user may submit a search query to a search engine, in anticipation of receiving documents that are relevant to the user's intended meaning of search terms, even though exact terms of the query may not be present in the relevant documents.

Much research has been devoted to techniques for determining term similarities, relatedness of terms in vocabularies, and relatedness of terms to various documents and collections. For example, models such as co-occurrence matrices may be used to electronically represent items such as terms and documents, indicating (at least) which terms are included in the documents.

### SUMMARY

According to one general aspect, a document-term matrix may be generated based on a corpus. A term representation matrix may be generated based on modifying a plurality of elements of the document-term matrix based on antonym information included in the corpus. Similarities may be determined based on a plurality of elements of the term representation matrix.

According to another aspect, a computer program product tangibly embodied on a computer-readable storage medium may include executable code that may cause at least one data processing apparatus to obtain a first term that is included in a vocabulary. Further, the at least one data processing apparatus may determine an antonym associated with the first term, based on accessing a first polarity indicator associated with the first term in a term co-occurrence matrix and a second polarity indicator associated with the antonym in the term co-occurrence matrix.

According to another aspect, a system may include an initial model generator configured to generate an initial document-term matrix based on a thesaurus. The system may also include a term representation generator configured to generate a term representation matrix based on modifying a plurality of elements of the initial document-term matrix based on antonym information associated with the plurality of elements of the initial document-term matrix, based on latent semantic analysis.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. The details of one or more implementations are set forth in the accompanying drawings and the description below. Other features will be apparent from the description and drawings, and from the claims.

### DRAWINGS

FIG. 1 is a block diagram of an example system for determining synonym-antonym polarity in term vectors.

FIG. 2 illustrates a sphere representation depicting representation mappings in an example semantic space.

FIG. 3 illustrates a sphere representation depicting representation mappings in an example semantic space, using an example polarity technique.

FIG. 4 is a flowchart illustrating example operations of the system of FIG. 1.

FIG. 5 is a flowchart illustrating example operations of the system of FIG. 1.

FIG. 6 is a flowchart illustrating example operations of the system of FIG. 1.

### DETAILED DESCRIPTION

I. Introduction

Vector space representations have proven useful across a wide variety of text processing applications ranging from document clustering to search relevance measurement. In these applications, text may be represented as a vector in a multi-dimensional continuous space, and a similarity metric such as cosine similarity may be used to measure the relatedness of different items. Vector space representations may be used both at the document and word levels. At the document level, they are effective for applications including information retrieval. At the word level, vector representations may be used to measure word similarity and for language modeling. Such applications have been consistent with a general notion of similarity in which basic association is measured, and finer shades of meaning are not be distinguished. For example, latent semantic analysis might assign a high degree of similarity to opposites as well as synonyms, as discussed in T. K. Landauer et al., “Learning humanlike knowledge by singular value decomposition: A progress report,” In Neural Information Processing Systems (NIPS), 1998.

Conventional vector space models may map synonyms and antonyms to similar word vectors, which do not represent antonym relationships among the mapped terms. According to example embodiments as discussed herein, vector space representations may be generated such that antonyms lie at opposite sides of a sphere. Thus, for example, in a word vector space, term pairs may have similarity values that reflect the nature of the antonym relationship between the terms. For example, synonyms may have cosine similarity values close to one, while antonyms have cosine similarity values that are close to minus one.

The vector space representations may be generated with the aid of a thesaurus and latent semantic analysis (LSA). For example, each entry in the thesaurus (e.g., a word sense along with its synonyms and antonyms) may be treated as a “document,” and the resulting document collection may be subjected to LSA. For example, signs may be assigned to the entries in co-occurrence matrices on which LSA operates, so as to induce a subspace with the property that term pairs may have similarity values that reflect the nature of the antonym relationship between the terms (e.g., synonyms have cosine similarity values close to one, while antonyms have cosine similarity values that are close to minus one), in the word space.

The subspace representation may be refined via discriminative training. According to example embodiments discussed herein, the training data may be augmented with terms from a general corpus (other than the thesaurus), such as a corpus of general newspaper text.

Latent semantic analysis (LSA) has been used, for example, to answer relatedness questions with regard to relatedness of pairs of words, pairs of documents, and relatedness of words to documents. For example, a user of a semantic analysis technique may wish to determine the relatedness of pairs of words such as {hot, cold} or {garage, sky}. For example, he/she may wish to determine the relatedness of pairs of documents such as {“Russian scientists recently succeeded in growing a flower from a 30,000 year old seed . . . ”, “For the first time, scientists have grown a plant from a 30,000 year old seed . . . ”}. As another example, he/she may wish to determine the relatedness of a word to a document such as {“germination”, “Russian scientists recently succeeded in growing a flower from a 30,000 year old seed . . . ”}.

However, such conventional LSA techniques measure co-occurrence relatedness, and have not focused on identifying antonym relatedness of entities. In this context, “antonyms” may refer to entities such as terms that have meanings opposite to each other. For example, the words “hot” and “cold” may have opposite meanings, and are thus pairwise antonyms. In this context, a “word” may refer to a single symbol or combination of symbols from an alphabet, which comprises a smallest indivisible unit of a vocabulary of a language. In this context, a “term” may include a string of one or more words.

In this context, a “document” may include a collection of one or more terms. In this context, a “thesaurus” may include a collection of entries that include terms and a group of associated related terms. For example, a “document” may include an entry in a thesaurus, such as {awkward, clumsy, gauche, graceless, inelegant, rough-hewn, rustic, stiff, stilted, uncomfortable, uneasy, ungraceful, wooden, graceful, suave, urbane}, which may include related terms including synonyms and antonyms of a term (e.g., “awkward” as a term for this example).

According to an example embodiment, a document-term matrix may be generated, where a document includes a group of words in a thesaurus entry, and a term is a word. The thesaurus may include groups of synonyms and antonyms.

In each row (column) of the document-term matrix, if a term belongs to the synonym group, then its weight is determined as a positive term frequency-inverse document frequency (TFIDF) value; if it belongs to the antonym group, then its weight is determined as a negative TFIDF value. The original matrix may then be projected to a concept-term space using singular value decomposition (SVD). The synonym/antonym score of any pair of words/terms in the thesaurus may be derived by the cosine score of their corresponding columns (rows) in the projected matrix. The resulting model is a vector space representation in which synonyms cluster together, and the opposites of a word tend to cluster together at the opposite end of a sphere.

When a test word is not in the thesaurus, it may be mapped to the thesaurus space by using a normal, or general corpus. For example, the general corpus may include an unsupervised corpus such as WIKIPEDIA, or a newspaper or journal archive.

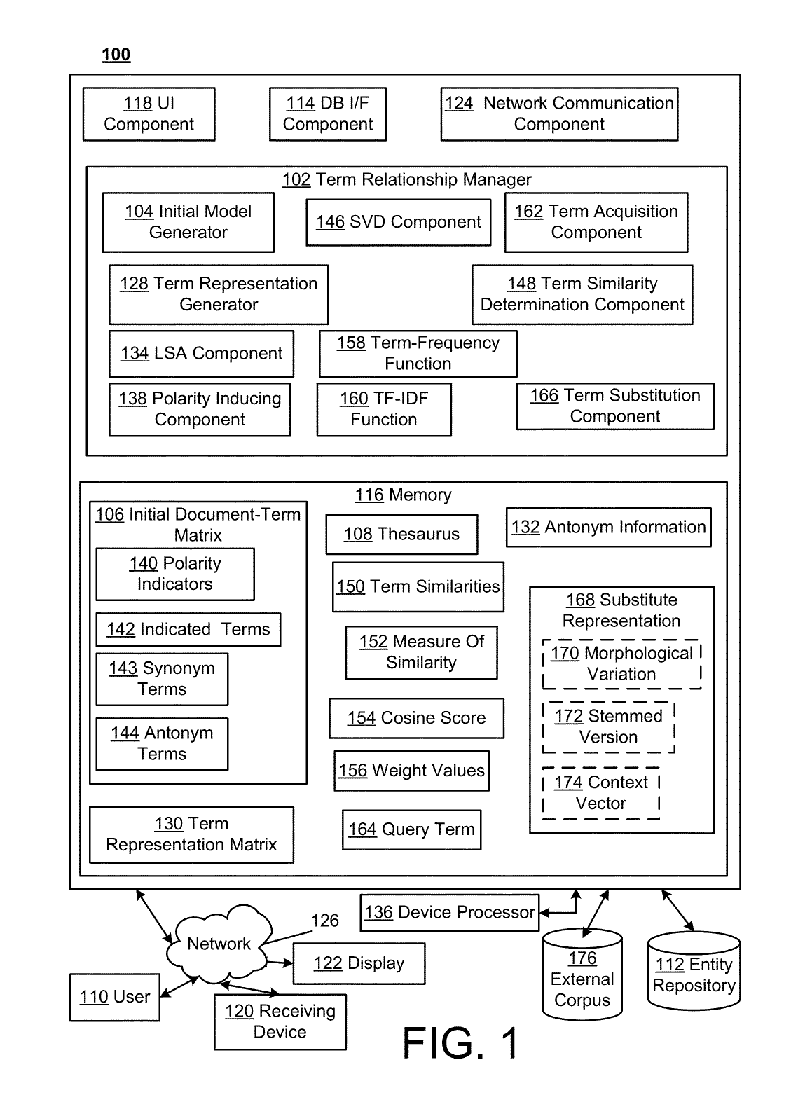

As further discussed herein, FIG. 1 is a block diagram of an example system 100 for determining synonym-antonym polarity in term vectors. As shown in FIG. 1, a system 100 may include a term relationship manager 102 that includes an initial model generator 104 that may be configured to generate an initial document-term matrix 106 based on a thesaurus 108. For example, a user 110 may be in communication with the term relationship manager 102 via a user device.

II. Example Operating Environment

Features discussed herein are provided as example embodiments that may be implemented in many different ways that may be understood by one of skill in the art of data processing, without departing from the spirit of the discussion herein. Such features are to be construed only as example embodiment features, and are not intended to be construed as limiting to only those detailed descriptions.

The term relationship manager 102, or one or more portions thereof, may include executable instructions that may be stored on a tangible computer-readable storage medium, as discussed below. For example, the computer-readable storage medium may include any number of storage devices, and any number of storage media types, including distributed devices.

For example, an entity repository 112 may include one or more databases, and may be accessed via a database interface component 114. One skilled in the art of data processing will appreciate that there are many techniques for storing repository information discussed herein, such as various types of database configurations (e.g., relational databases, hierarchical databases, distributed databases) and non-database configurations.

The term relationship manager 102 may include a memory 116 that may store the initial document-term matrix 106. In this context, a “memory” may include a single memory device or multiple memory devices configured to store data and/or instructions. Further, the memory 116 may span multiple distributed storage devices.

A user interface component 118 may manage communications between the user 110 and the term relationship manager 102. The user 110 may be associated with a receiving device 120 that may be associated with a display 122 and other input/output devices. For example, the display 122 may be configured to communicate with the receiving device 120, via internal device bus communications, or via at least one network connection.

The display 122 may be implemented as a flat screen display, a print form of display, a two-dimensional display, a three-dimensional display, a static display, a moving display, sensory displays such as tactile output, audio output, and any other form of output for communicating with a user (e.g., the user 110).

The term relationship manager 102 may include a network communication component 124 that may manage network communication between the term relationship manager 102 and other entities that may communicate with the term relationship manager 102 via at least one network 126. For example, the network 126 may include at least one of the Internet, at least one wireless network, or at least one wired network. For example, the network 126 may include a cellular network, a radio network, or any type of network that may support transmission of data for the term relationship manager 102. For example, the network communication component 124 may manage network communications between the term relationship manager 102 and the receiving device 120. For example, the network communication component 124 may manage network communication between the user interface component 118 and the receiving device 120.

A term representation generator 128 may be configured to generate a term representation matrix 130 based on modifying a first plurality of elements of the initial document-term matrix 106 based on antonym information 132 associated with the first plurality of elements, based on latent semantic analysis. For example, a latent semantic analysis (LSA) component 134 may perform the LSA.

For example, the term representation generator 128 may be configured to generate the term representation matrix 130 via a device processor 136. In this context, a “processor” may include a single processor or multiple processors configured to process instructions associated with a processing system. A processor may thus include one or more processors processing instructions in parallel and/or in a distributed manner. Although the device processor 136 is depicted as external to the term relationship manager 102 in FIG. 1, one skilled in the art of data processing will appreciate that the device processor 136 may be implemented as a single component, and/or as distributed units which may be located internally or externally to the term relationship manager 102, and/or any of its elements.

Latent Semantic Analysis (LSA) is an example technique for representing words and documents in a low dimensional vector space, as discussed by S. Deerwester, et al., “Indexing by latent semantic analysis,” Journal of the American Society for Information Science, 41(96), 1990. For example, the technique may be based on applying singular value decomposition (SVD) to a matrix W which indicates the occurrence of words in documents. For example, the input may include a collection of d documents which are expressed in terms of words from a vocabulary of size n. These documents may be actual documents such as newspaper articles, or notional documents such as sentences, or any other collection in which words may be grouped together.

For example, a d×n (or, alternatively, n×d) document-term matrix W may be generated. In one example form, the ij^{th} entry may represent the number of times a word j occurs in document i—its term frequency, or TF value. For example, the entry may be weighted by some notion of the importance of word j, for example the negative logarithm of the fraction of documents that contain it, resulting in a TF-IDF weighting, as discussed in G. Salton, et al., “A Vector Space Model for Automatic Indexing,” Communications of the ACM, 18(11), 1975.

For example, a similarity between two documents may be determined using a cosine similarity of their corresponding row vectors (or, alternatively, column vectors), which may be denoted as:

$$sim ( x , y ) = \frac{x \cdot y}{‖ x ‖ ‖ y ‖} \qquad Eq . ( 1 )$$

Similarly, the cosine similarity of two column vectors may be used to judge the similarity of the corresponding words.

For example, to obtain a subspace representation of dimension k, W may be decomposed as

W≈USV Eq. (2)

wherein U is d×k, V^{T} is k×n, and S is a k×k diagonal matrix. For example, k<<n and k<<d (e.g., the rank of the decomposed matrix is substantially less than the rank of W before decomposition). For example, a user may have a 50,000 word vocabulary and 1,000,000 documents, and may use a 300 dimensional subspace representation.

A property associated with SVD is that the columns of SV^{T} (which now represent the words) behave similarly to the original columns of W, in the sense that the cosine similarity between two columns in SV^{T} approximates the cosine similarity between the corresponding columns in W. For example, this follows from an observation that W^{T}W=VS²V^{T}, and an observation that the ij^{th} entry of W^{T}W is the dot product of the i^{th} and j^{th} columns (or words) in W. For efficiency, the columns of SV^{T} may be normalized to unit length, allowing the cosine similarity between two words to be determined with a single dot-product; this also has the property of mapping each word to a point on a multi-dimensional sphere.

Another property of LSA is that the word representations which result may be viewed as the result of applying a projection matrix U to the original vectors, which may be denoted as:

U^{T}W=SV^{T} Eq. (3)

Word similarity as determined by LSA may assign high values to words which tend to co-occur in documents. However, as noted by T. K. Landauer et al., “Learning humanlike knowledge by singular value decomposition: A progress report,” In Neural Information Processing Systems (NIPS), 1998, there is no notion of antonymy in conventional LSA, as words with low or negative cosine scores may be viewed as unrelated. In comparison, words with high cosine similarity scores may be determined as semantically related, which includes both synonyms and antonyms, as contrasting words may frequently co-occur.

In experimental testing, SVD may be performed with the aid of the ENCARTA thesaurus developed by Bloomsbury Publishing Plc. For example, this example thesaurus contains approximately 47,000 word senses and a vocabulary of 50,000 words and phrases. Each “document” is interpreted as the thesaurus entry for a word-sense, including synonyms and antonyms. For example, the word “admirable” may induce a document that includes {admirable, estimable, commendable, venerable, good, splendid, worthy, marvelous, excellent, unworthy}. For this example, the last word in this set is its antonym. Performing SVD on this set of thesaurus derived “meaning-documents” may generate a subspace representation for each word.

As shown below, Table 1 illustrates a group of words, their original thesaurus documents, and the most and least similar words in the LSA subspace.

TABLE 1

| | Thesaurus | LSA Most-Similar | LSA Least-Similar |
|---|---|---|---|
| Word | Entry | Words | Words |
| admirable | estimable, | commendable, | easy-on-the-eye, |
| | commendable, | creditable, | peace-keeper, |
| | venerable, | laudable, | peace-lover, |
| | good, | praiseworthy, | conscientious- |
| | splendid, | worthy, | objector, |
| | worthy, | meritorious, | uninviting, |
| | marvelous, | scurvy, | dishy, dessert, |
| | excellent, | contemptible, | pudding, |
| | unworthy | despicable, | seductive |
| | | estimable | |
| considered | careful, | calculated, | ready-made-meal, |
| | measured, well- | premeditated, | ready-meal, |
| | thought-out, | planned, tactical, | disposed-to, |
| | painstaking, rash | strategic, thought- | apt-to, wild- |
| | | through, | animals, big- |
| | | intentional, | game, game-birds, |
| | | fortuitous, | game-fish, rugger, |
| | | purposeful, | rugby |
| | | unpremeditated | |
| mourning | grief, | sorrowfulness, | muckiness, turn- |
| | bereavement, | anguish, | the-corner, |
| | sorrow, sadness, | exultation, | impassibility, |
| | lamentation, woe, | rejoicing, | filminess, |
| | grieving, | jubilation, glee, | pellucidity, |
| | exultation | heartache, travail, | limpidity, |
| | | joy, elation | sheerness |

As shown in Table 1, the example vector-space representation of words may identify related words that are not explicitly present in the original thesaurus. For example, “meritorious” may be identified as related to “admirable”, which may be more desirable than words provided by the thesaurus itself.

According to the example of Table 1, similarity is based on co-occurrence, so the co-occurrence of antonyms in the thesaurus-derived documents induces their presence as LSA-similar words. For example, “contemptible” is identified as similar to “admirable” as shown in Table 1. In the case of “mourning,” opposites such as “joy” and “elation” may be interpreted as dominating the list of LSA-similar words.

According to the example of Table 1, the LSA-least-similar words may be viewed as having no relationship at all to the word they are least-similar to. For example, the least-similar word to “considered” is “ready-made-meal.”

As discussed further below, polarity may be induced in LSA subspaces, where opposite words may tend to have negative cosine similarities, somewhat analogous to the positive similarities of synonyms. Thus, for example, the least-similar words to a given word may be its opposites.

Features discussed below are provided as example embodiments that may be implemented in many different ways that may be understood by one of skill in the art of data processing, without departing from the spirit of the discussion herein. Such features are to be construed only as example embodiment features, and are not intended to be construed as limiting to only those detailed descriptions.

A polarity inducing component 138 may be configured to determine polarity indicators 140 associated with a group of indicated terms 142 included in the initial document-term matrix 106, each of the indicated terms 142 having an associated set of synonym terms 143 representing synonyms to the respective associated indicated term 142, and an associated set of antonym terms 144 representing antonyms to the respective associated indicated term 142. The determined polarity indicators 140 may include a first set of term polarity indicators assigned to the indicated terms 142 and their respective associated set of synonym terms 143, and a second set of term polarity indicators assigned to each respective set of antonym terms 144 associated with each respective indicated term 142. The first set of term polarity indicators may represent a synonymy polarity that is opposite to an antonymy polarity represented by the second set of term polarity indicators. For example, an example indicated term 142 and its associated synonyms may have positive numeric signs assigned to their representations, while the antonyms associated with the example indicated term 142 may have negative numeric signs assigned to their representations (e.g., +1 for synonymous terms, −1 for their associated antonymous terms).

In this context, “synonymy” may refer to a property of terms having similar, or substantially similar, meanings (e.g., terms related as synonyms in a vocabulary). In this context, “antonymy” may refer to a property of terms having opposite, or substantially opposite, meanings (e.g., terms related as antonyms in a vocabulary). In this context, “polarity” may refer to an indication that a term may be considered relative to another term based on representations using a concept of axes in space (e.g., axes in one-dimensional or multi-dimensional space).

For example, each of the term polarity indicators that are included in the second set of term polarity indicators may include a negated numeric sign relative to a numeric sign of the term polarity indicators in the first set of term polarity indicators.

LSA may be modified, for example, to exploit a thesaurus to embed meaningful axes in the induced subspace representation. For example, based on such axes, words with opposite meaning may lie at opposite positions on a sphere. As discussed above, the cosine similarity between word-vectors in the original matrix W are preserved in the subspace representation of words. Thus, if the original matrix is generated such that the columns representing antonyms tend to have negative cosine similarities while columns representing synonyms tend to have positive similarities, the desired behavior may be achieved.

For example, the TF-IDF entries for the antonyms of a word may be negated when constructing W from the thesaurus, which is illustrated by examples shown in Tables 2 and 3 below.

TABLE 2

| | acrimony | rancor | goodwill | affection |
|---|---|---|---|---|
| acrimony | 1 | 1 | 1 | 1 |
| affection | 1 | 1 | 1 | 1 |

Table 2 illustrates an example matrix W for two thesaurus entries (for “acrimony” and “affection”) in its original form, wherein rows represent documents, and columns represent words.

TABLE 3

| | acrimony | rancor | goodwill | affection |
|---|---|---|---|---|
| acrimony | 1 | 1 | −1 | −1 |
| affection | −1 | −1 | 1 | 1 |

Table 3 illustrates an example matrix W for two thesaurus entries (for “acrimony” and “affection”) in polarity-inducing form, wherein rows represent documents, and columns represent words.

The two rows in Tables 2 and 3 may correspond to thesaurus entries for the sense-categories “acrimony,” and “affection.” The thesaurus entries may induce two “documents” that include the words and their synonyms and antonyms. As shown in Tables 2 and 3, the complete set of words includes “acrimony,” “rancor,” “goodwill,” and “affection.” For simplicity, all TF-IDF weights are shown as having a value of 1 for the example of in Tables 2 and 3.

Table 2 illustrates an example original LSA formulation. “Rancor” is listed as a synonym of “acrimony,” which has “goodwill” and “affection” as its antonyms. This results in the first row. As shown in the example of Table 2, the cosine similarity between every pair of words (columns) is 1.

Table 3 illustrates an example corresponding polarity-inducing representation. As shown in the example of Table 3, the cosine similarity between synonymous words (columns) is 1, and the cosine similarity between antonymous words is −1. For example, since LSA may tend to preserve cosine similarities between words, it may be expected that the resulting subspace may be viewed as having meaningful axes, where opposite senses may map to opposite extremes. For example, this may be referred to herein as polarity-inducing LSA (PILSA).

Thus, the term representation generator 128 may be configured to generate the term representation matrix 130 based on an approximation of the initial document-term matrix 106 based on latent semantic analysis. For example, the term representation matrix 130 may be of substantially lower rank than the initial document-term matrix 106, as discussed above.

For example, the term representation generator 128 may be configured to generate the term representation matrix 130 based on an approximation of the initial document-term matrix 106 with singular value decomposition. For example, a singular value decomposition (SVD) component 146 may be configured to perform the SVD. One of skill in the art will understand that there may be many ways to generate the term representation matrix 130, other than SVD, without departing from the spirit of the discussion herein. For example, the term representation matrix 130 may be obtained via eigen-decomposition on a corresponding covariance matrix

A term similarity determination component 148 may be configured to determine, via the device processor 134, term similarities 150 based on a plurality of elements of the term representation matrix 130.

For example, the term similarity determination component 148 may be configured to determine a measure of similarity 152 between pairs of terms included in the thesaurus 108, based on one or more of generating a cosine score 154 of corresponding column vectors included in the term representation matrix 130 that correspond to respective terms included in the pairs, or generating a cosine score 154 of corresponding row vectors included in the term representation matrix 130 that correspond to respective terms included in the pairs.

The initial model generator 104 may be configured to generate the initial document-term matrix 106 based on determining respective weight values 156 for each element of the initial document-term matrix 106, based on one or more of a term-frequency function 158, or a term frequency times inverse document frequency (TF-IDF) function 160.

Table 4, as shown below, illustrates PILSA-similar and PILSA-least-similar words for the same words as in Table 1.

TABLE 4

| Word | PILSA-Similar Words | PILSA-Least-Similar Words |
|---|---|---|
| admirable | commendable, creditable, | scurvy, contemptible, |
| | laudable, praiseworthy, | despicable, lamentable, |
| | worthy, meritorious, | shameful, reprehensible, |
| | estimable, deserving, tiptop, | unworthy, disgraceful, |
| | valued | discreditable, undeserving |
| considered | calculated, premeditated, | fortuitous, unpremeditated, |
| | planned, tactical, strategic, | unconsidered, off-your-own- |
| | thought-through, intentional, | bat, unintended, undirected, |
| | purposeful, intended, | objectiveless, hit-and-miss, |
| | psychological | unforced, involuntary |
| mourning | sorrowful, doleful, sad, | smiley, happy, blissful, |
| | miserable, wistful, pitiful, | wooden, mirthful, joyful, |
| | wailing, sobbing, heavy- | deadpan, fulfilled, straight- |
| | hearted, forlorn | faced, content |

As shown in the example of Table 4, words which are least similar in the sense of having the lowest cosine-similarity are considered as opposites. For the example of Table 4, generally the most similar words have similarities in the range of 0.7 to 1.0 and the least similar words have similarities in the range of −0.7 to −1.0.

The term relationship manager 102 may further include a term acquisition component 162 that may be configured to obtain a query term 164.

For example, a term substitution component 166 may be configured to determine a substitute representation 168 for the query term 164, if the query term 164 is not included in the thesaurus 108. For example, the term substitution component 166 may determine the substitute representation 168 for the query term 164 based on one or more of a morphological variation 170 of the query term 164, a stemmed version 172 of the query term 164, or a context vector 174 representing the query term 164, wherein the context vector 174 is generated based on a corpus that includes terms that are not included in the thesaurus 108. For example, an external corpus 176 may include terms that are not included in the thesaurus 108. For example, the external corpus 176 may include full text of various document archives, such as journals, newspapers, periodicals, etc.

Although the cosine similarity of LSA-derived word vectors may generally be effective in example applications such as judging the relevance of words or documents, or detecting antonyms (as discussed herein), the example technique of singular value decomposition in LSA may not explicitly try to achieve such goals. For example, when supervised training data is available, the projection matrix of LSA may be enhanced via an example discriminative training technique designed to create a representation suited to a specific task.

Because LSA is closely related to principle component analysis (PCA), extensions of PCA such as canonical correlation analysis (CCA) and oriented principle component analysis (OPCA) may leverage the labeled data and produce the projection matrix through general eigen-decomposition, as discussed by Platt et al., “Translingual document representations from discriminative projections,” In Proceedings of EMNLP (2010), pp. 251-261.

Along this line of work, Yih et al., “Learning discriminative projections for text similarity measures,” In Proceedings of the Fifteenth Conference on Computational Natural Language Learning (CoNLL), 2011, pp. 247-256 discusses a Siamese neural network approach referred to as S2Net, which may tune the projection matrix directly through gradient descent, and may outperform other methods in several tasks. As discussed below, this example technique may be employed for the task of antonym detection.

An example goal of S2Net is to learn a concept vector representation of the original sparse term vectors. Although such transformation may be non-linear in general, an example design may choose the model form as a linear projection matrix, which may be substantially similar to that of LSA, PCA, OPCA or CCA.

For example, given a d-by-1 input vector f, an example model of S2Net may include a d-by-k matrix A=[aᵢⱼ]_{d×k}, which maps f to a k-by-1 output vector g=A^{T}f. For example, the transformation may be viewed as a two-layer neural network.

For example, S2Net may be distinguished from other approaches based on its loss function and optimization process. In the “parallel text” setting, the labeled data may include pairs of similar text objects such as documents. For example, an objective of the training process may include assigning higher cosine similarities to these pairs compared to others. More specifically, the training set may include m pairs of raw input vectors {(fₚ₁,f_{q1}), (fₚ₂,f_{q2}), . . . , (fₚₘ,f_{qm})}. Given a projection matrix A, a similarity score of any pair of objects may be determined as sim_{A}(fₚᵢ, f_{qj})=cosine(A^{T}fₚᵢ, A^{T}f_{qj}). For example, Δᵢⱼ=simA(fₚᵢ, f_{qi})−simA(fₚᵢ, f_{qi}) may represent a difference of the similarity scores of (fₚᵢ, f_{qi}) and (fₚᵢ, f_{qj}). The example learning procedure may attempt to increase Δᵢⱼ by using an example logistic loss which may be denoted as:

L(Δᵢⱼ;A)=log(1+exp(−γΔᵢⱼ)), Eq. (4)

where γ is a scaling factor that adjusts the loss function. The loss of the whole training set may thus be denoted as:

$$\frac{1}{m ( m - 1 )} {\sum }_{i \leq i , j \leq m , i \neq j}^{ } L ( Δ ij ; A ) \qquad Eq . ( 5 )$$

Parameter learning (e.g., tuning A) may be performed by standard gradient-based methods, such as LBFGS (Limited-memory Broyden-Fletcher-Goldfarb-Shanno method), as discussed by Nocedal and Wright, Numerical Optimization, Springer, 2nd edition (2006).

For example, the original setting of S2Net may be directly applied to finding synonymous words, where the training data may include pairs of vectors representing two synonyms. The loss function may be modified to apply it to the antonym detection problem. For example, pairs of antonyms from the thesaurus may be sampled to create the training data. The raw input vector f of a selected word is its corresponding column vector of the document-term matrix W after inducing polarity. When each pair of vectors in the training data represents two antonyms, Aᵤ may be redefined by flipping the sign, as denoted by Δᵢⱼ=simA(fₚᵢ, f_{qi})−simA(fₚᵢ, f_{qi}), and by leaving others unchanged. As the loss function may encourage Aᵤ to be larger, an antonym pair may tend to have a smaller cosine similarity than other pairs. Because S2Net uses a gradient descent technique and a non-convex objective function, it is sensitive to initialization, and the PILSA projection matrix U (discussed above) may provide a desirable starting point.

In order to extend PILSA to operate on out-of-thesaurus words, an example two-stage technique may be used. For example, lexical analysis may be performed to attempt to match an unknown word to one or more in-thesaurus words in their lemmatized forms. If no such match is found, an attempt may be made to find semantically related in-thesaurus words by leveraging co-occurrence statistics from general text data, as discussed further below.

When a target word is not included in a thesaurus, it may be the case that some of its morphological variations are covered. For example, although the ENCARTA thesaurus may not have the word “corruptibility,” it may have other forms such as “corruptible” and “corruption.” Replacing the out-of-thesaurus target word with these morphological variations may alter the part-of-speech but typically may not change the meaning.

Given an out-of-thesaurus target word, an example morphological analyzer for English (e.g., as discussed by Minnen et al., “Applied morphological processing of English,” Natural Language Engineering, 7(3), 2001, pp. 207-223) may be applied, which removes the inflectional affixes and returns the lemma. If the lemma still does not exist in the thesaurus, an example stemmer (e.g., as discussed by Martin Porter, “An algorithm for suffix stripping,” Program, 14(3), 1980, pp. 130-137) may be applied.

It may then be determined whether the target word can match any of the in-thesaurus words in their stemmed forms. For example, a rule that checks whether removing hyphens from words can lead to a match and whether the target word occurs as part of a compound word in the thesaurus may be applied when both morphological analysis and stemming fail to find a match.

When there are more than one matched words, the centroid of their PILSA vectors may be used to represent the target word. When there is only one matched word, the matched word may be treated as the target word.

If no words in the thesaurus can be linked to the target word through the example lexical analysis technique discussed above, an example attempt to find matched words may be performed by creating a context vector space model from a large document collection, and then mapping from this space to the PILSA space. For example, contexts may be used because of the distributional hypothesis, that words that occur in the same contexts tend to have similar meaning (e.g., as discussed by Zelig Harris, “Distributional structure,” Word, 10(23), 1954, pp. 146-162). For example, when a word is not in the thesaurus but appears in the corpus, its PILSA vector representation may be predicted from the context vector space model by using its k-nearest neighbors which are in the thesaurus and which are consistent with each other.

When a corpus of documents is provided, the raw context vectors may be generated as discussed below. For example, for each target word, a bag of words may be determined based on collecting terms within a window of [−10,+10] centered at each occurrence of the target word in the corpus. The non-identical terms form a term-vector, where each term is weighted using its TF-IDF value. For example, LSA may then be performed on the context-word matrix. The semantic similarity/relatedness of two words may then be determined using the cosine similarity of their corresponding LSA word vectors. In the discussion below, this LSA context vector space model may be referred to as the corpus space, in contrast to the PILSA thesaurus space.

For example, given the context space model, a linear regression or a k-nearest neighbors technique may be used to embed out-of-thesaurus words into the thesaurus-space representation. However, as near words in the context space may be synonyms in addition to other semantically related words (including antonyms), such approaches may potentially be noisy. For example, words such as “hot” and “cold” may be close to each other in the context space due to their similar usage in text. For example, an affine transform may not “tear space” and map them to opposite poles in the thesaurus space.

Therefore, a revised k-nearest neighbors technique may be used. For example, a user may be interested in an out-of-thesaurus word w. According to an example embodiment, K-nearest in-thesaurus neighbors to w in the context space may be determined. A subset of k members of these K words may be selected such that the pairwise similarity of each of the k members with every other member is positive. According to an example embodiment, the thesaurus-space centroid of these k items may be computed as w's representation. This example technique may provide the property that the k nearby words used to form the embedding of a non-thesaurus word are selected to be consistent with each other.

For example, a selection of K=10 and k=3, which may involve approximately 1000 pairwise computations (e.g., even performed as a brute-force technique). As an example, if a user had an out-of-thesaurus word such as “sweltering” with in-thesaurus neighbors “hot, cold, burning, scorching, . . . ” the example technique may return the centroid of “hot, burning, scorching” and exclude “cold.”

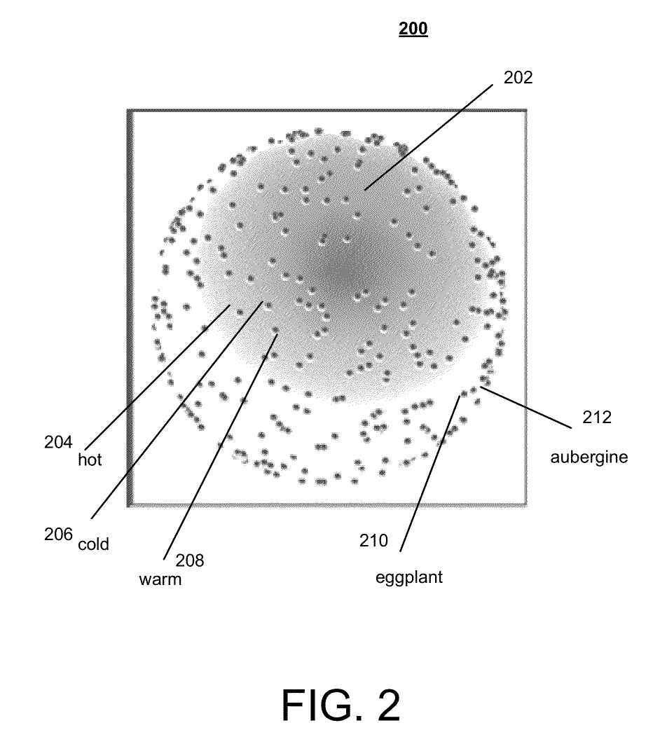

FIG. 2 illustrates a sphere representation depicting representation mappings in an example semantic space. As shown in FIG. 2, a sphere representation 202 includes points representing terms such as “hot” 204, “cold” 206, “warm” 208, “eggplant” 210, and “aubergine” 212 mapped to the surface of the sphere 202. For example, the mapping may be a result of applying LSA techniques, and may include normalizing word vectors to unit length to map the terms to the sphere 202. For example, similarity may be measured by cosine distance, as discussed above. For example, documents may be embedded in a related space.

As shown in FIG. 2, the LSA mapping places points representing the terms “hot” 204, “cold” 206, and “warm” 208 in close proximity to each other on the sphere 202. Thus, these terms may be determined as closely related under LSA, even though the term “cold” may be considered as an antonym to the term “hot.”

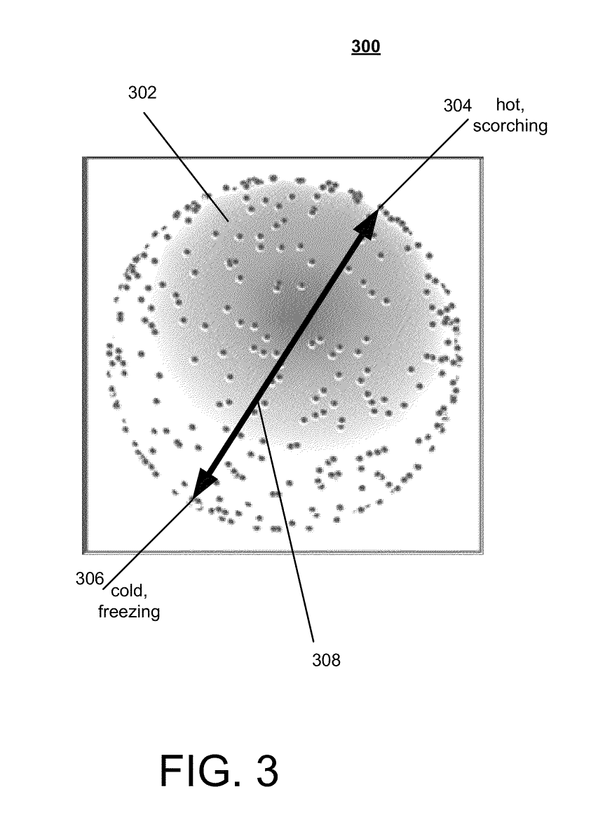

FIG. 3 illustrates a sphere representation depicting representation mappings in an example semantic space, using an example polarity technique. As shown in FIG. 3, a sphere representation 302 includes points representing terms such as “hot” and “scorching 304, and “cold” and “freezing” 306 mapped to the surface of the sphere 302. As shown in FIG. 3, the mapping depicts the points (e.g., 304 and 306) as located on opposite sides of the sphere 304, or as mapped to opposite polarities (as illustrated by an axis line 308). For example, the mapping may be a result of using a thesaurus to seed a representation where opposites are at opposite poles of the sphere 302, as discussed above. For example, general text data may be used to learn the embedding of non-thesaurus words.

III. Flowchart Description

Features discussed herein are provided as example embodiments that may be implemented in many different ways that may be understood by one of skill in the art of data processing, without departing from the spirit of the discussion herein. Such features are to be construed only as example embodiment features, and are not intended to be construed as limiting to only those detailed descriptions.

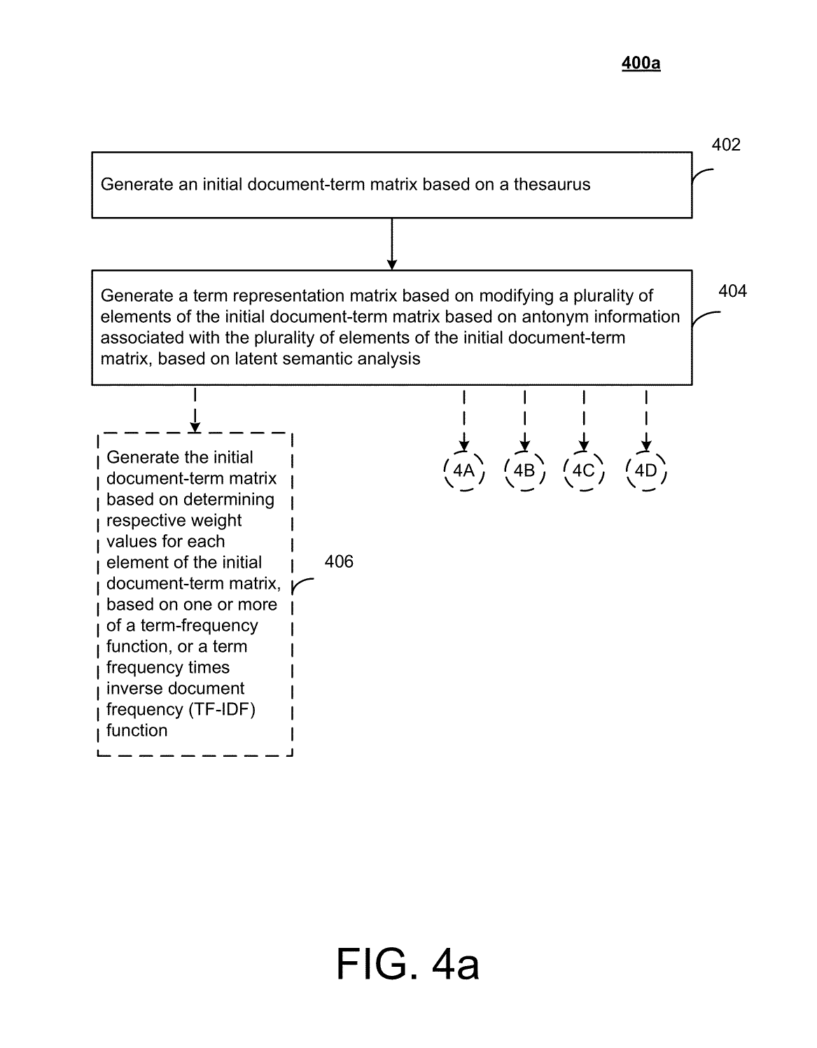

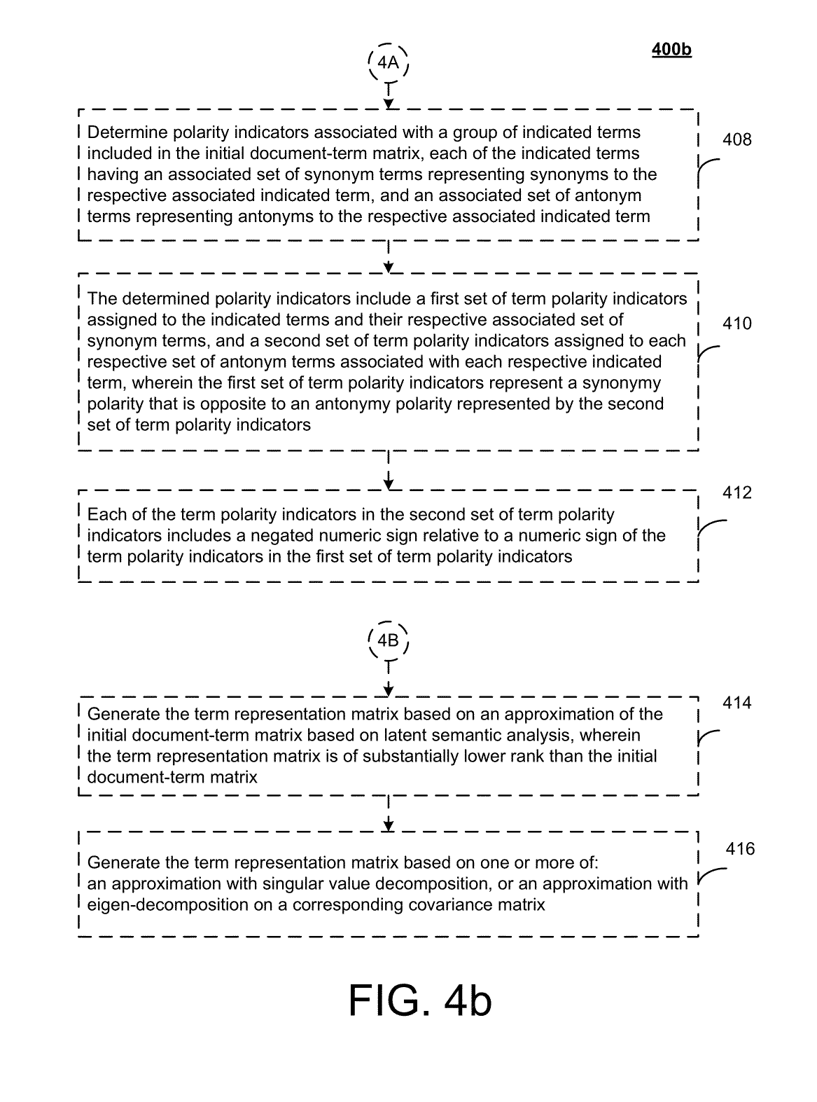

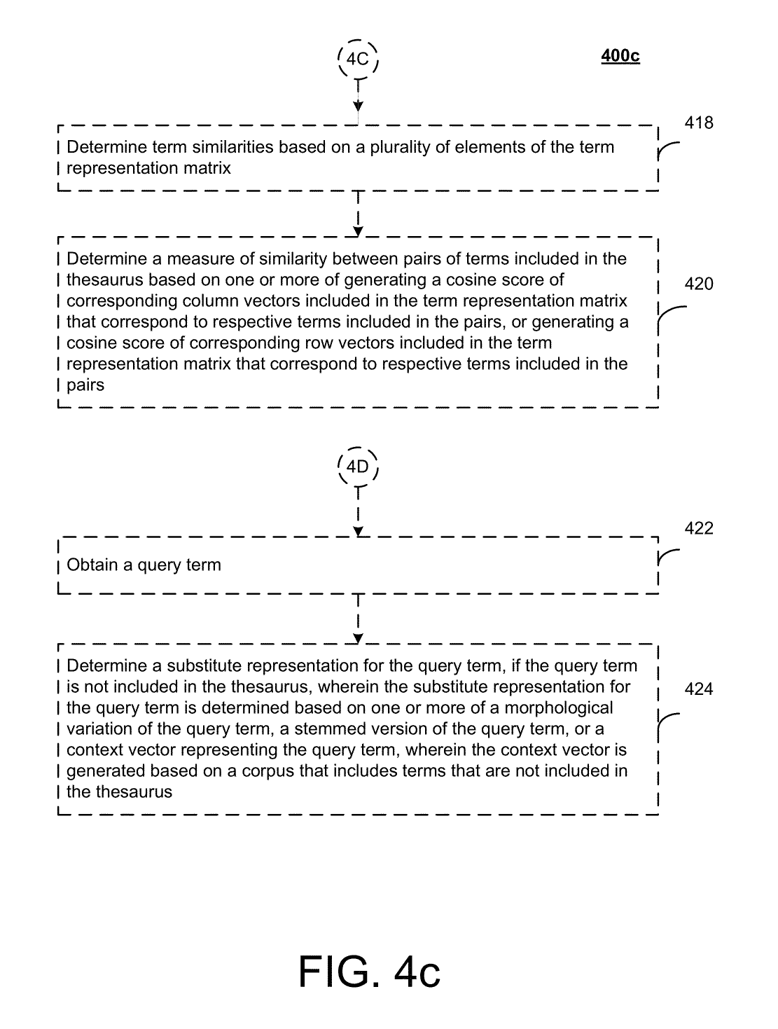

FIG. 4 is a flowchart illustrating example operations of the system of FIG. 1, according to example embodiments. In the example of FIG. 4a, an initial document-term matrix may be generated based on a thesaurus (402). For example, the initial model generator 104 may generate the initial document-term matrix 106 based on a thesaurus 108, as discussed above.

A term representation matrix may be generated based on modifying a plurality of elements of the initial document-term matrix based on antonym information associated with the plurality of elements of the initial document-term matrix, based on latent semantic analysis (404). For example, the term representation generator 128 may generate the term representation matrix 130 based on modifying a plurality of elements of the initial document-term matrix 106 based on antonym information 132 associated with the first plurality of elements of the initial document-term matrix 106, based on latent semantic analysis, as discussed above.

For example, the initial document-term matrix may be generated based on determining respective weight values for each element of the initial document-term matrix, based on one or more of a term-frequency function, or a term frequency times inverse document frequency (TF-IDF) function (406). For example, the initial model generator 104 may generate the initial document-term matrix 106 based on determining respective weight values 156 for each element of the initial document-term matrix 106, based on one or more of a term-frequency function 158, or a term frequency times inverse document frequency (TF-IDF) function 160, as discussed above.

For example, polarity indicators associated with a group of indicated terms included in the initial document-term matrix may be determined, each of the indicated terms having an associated set of synonym terms representing synonyms to the respective associated indicated term, and an associated set of antonym terms representing antonyms to the respective associated indicated term (408), in the example of FIG. 4b.

The determined polarity indicators may include a first set of term polarity indicators assigned to the indicated terms and their respective associated set of synonym terms, and a second set of term polarity indicators assigned to each respective set of antonym terms associated with each respective indicated term (410).

For example, the first set of term polarity indicators may represent a synonymy polarity that is opposite to an antonymy polarity represented by the second set of term polarity indicators (412).

For example, the term representation matrix may be generated based on an approximation of the initial document-term matrix based on latent semantic analysis, wherein the term representation matrix is of substantially lower rank than the initial document-term matrix (414). For example, the term representation generator 128 may generate the term representation matrix 130 based on an approximation of the initial document-term matrix 106 based on latent semantic analysis. According to an example embodiment, the term representation matrix 130 is of substantially lower rank than the initial document-term matrix 106, as discussed above.

The term representation matrix may be generated based on one or more of an approximation with singular value decomposition, or an approximation with eigen-decomposition on a corresponding covariance matrix (416).

Term similarities may be determined based on a plurality of elements of the term representation matrix (418), in the example of FIG. 4c. For example, the term similarity determination component 148 may determine, via the device processor 134, term similarities 150 based on a plurality of elements of the term representation matrix 130, as discussed above.

For example, a measure of similarity between pairs of terms included in the thesaurus may be determined based on one or more of generating a cosine score of corresponding column vectors included in the term representation matrix that correspond to respective terms included in the pairs, or generating a cosine score of corresponding row vectors included in the term representation matrix that correspond to respective terms included in the pairs (420). For example, the term similarity determination component 148 may determine a measure of similarity 152 between pairs of terms included in the thesaurus 108, based on one or more of generating a cosine score 154 of corresponding column vectors included in the term representation matrix 130 that correspond to respective terms included in the pairs, or generating a cosine score 154 of corresponding row vectors included in the term representation matrix 130 that correspond to respective terms included in the pairs, as discussed above.

A query term may be obtained (422). For example, the term acquisition component 162 may obtain the query term 164, as discussed above.

A substitute representation for the query term may be determined, if the query term is not included in the thesaurus. The substitute representation may be determined based on one or more of a morphological variation of the query term, a stemmed version of the query term, or a context vector representing the query term, wherein the context vector is generated based on a corpus that includes terms that are not included in the thesaurus (424). For example, the term substitution component 166 may be configured to determine a substitute representation 168 for the query term 164, if the query term 164 is not included in the thesaurus 108. For example, the term substitution component 166 may determine the substitute representation 168 for the query term 164 based on one or more of a morphological variation 170 of the query term 164, a stemmed version 172 of the query term 164, or a context vector 174 representing the query term 164, wherein the context vector 174 is generated based on a corpus that includes terms that are not included in the thesaurus 108, as discussed above.

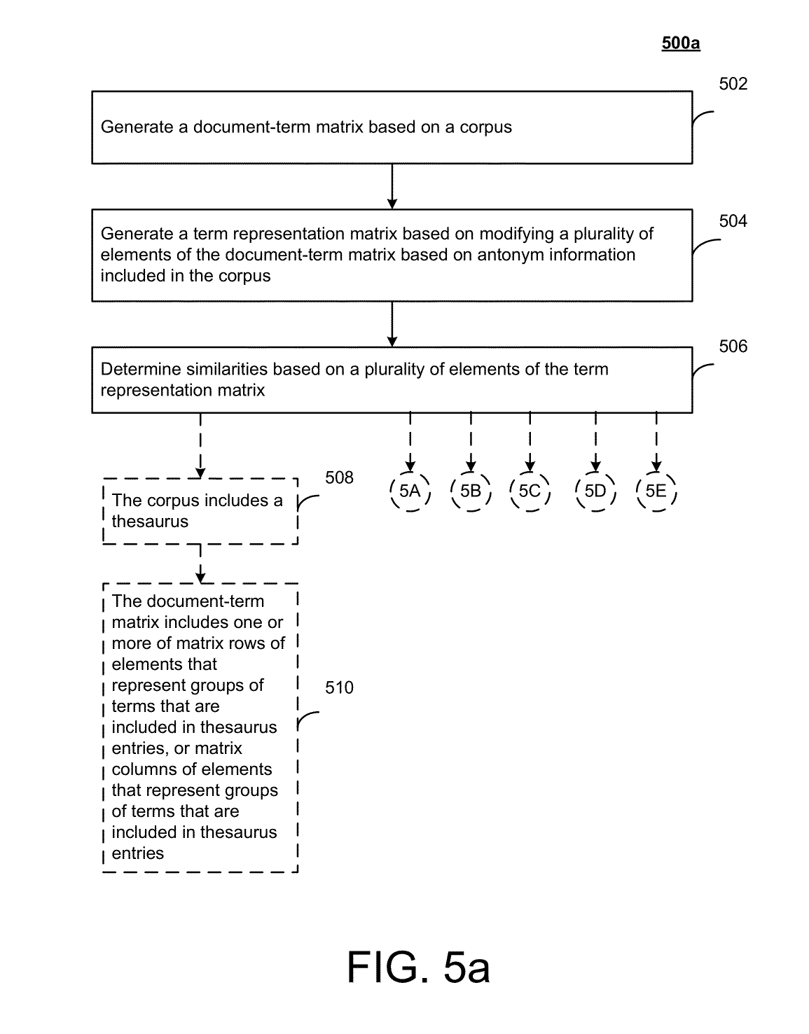

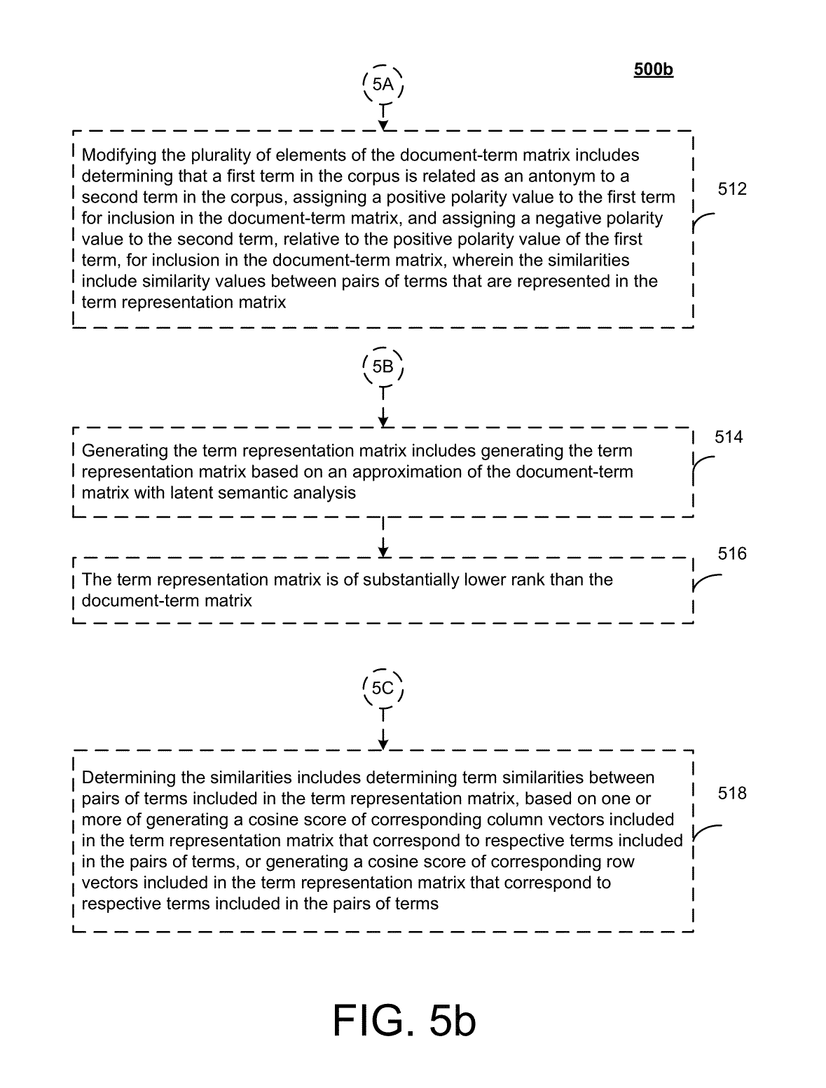

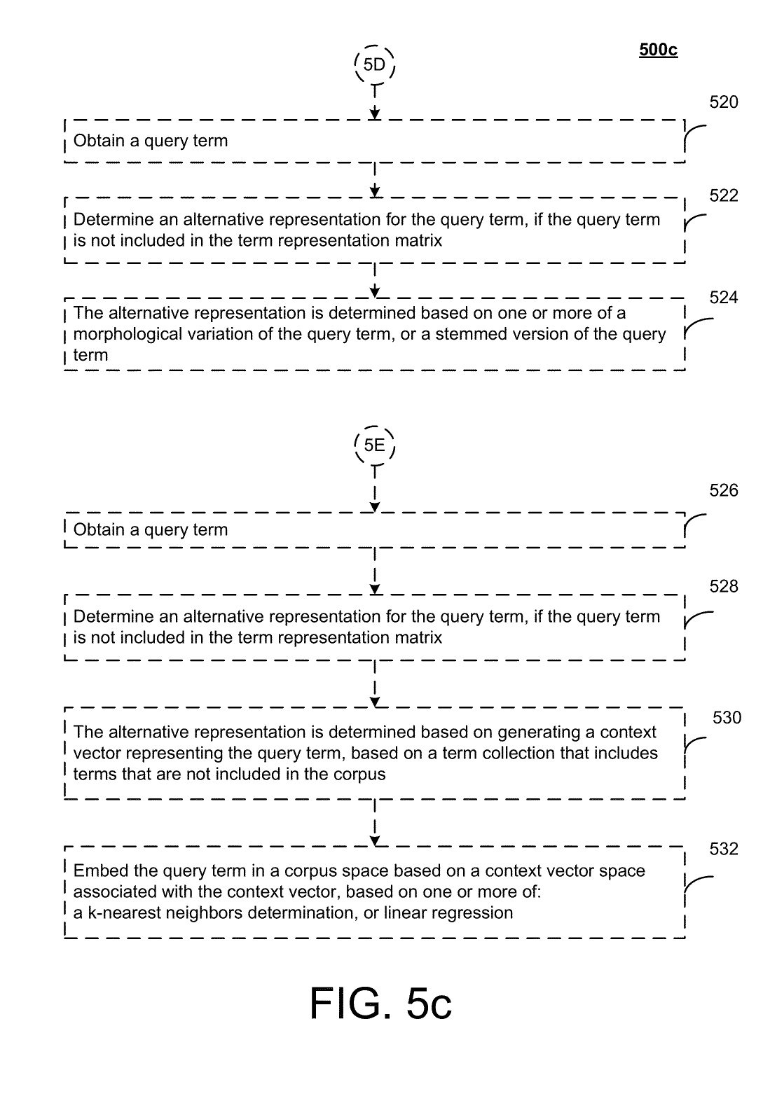

FIG. 5 is a flowchart illustrating example operations of the system of FIG. 1, according to example embodiments. In the example of FIG. 5a, a document-term matrix may be generated based on a corpus (502). For example, the initial model generator 104 may generate the initial document-term matrix 106, as discussed above.

A term representation matrix may be generated based on modifying a plurality of elements of the document-term matrix based on antonym information included in the corpus (504). For example, the term representation generator 128 may generate the term representation matrix 130, as discussed above.

Similarities may be determined based on a plurality of elements of the term representation matrix (506). For example, the term similarity determination component 148 may determine term similarities 150, as discussed above.

For example, the corpus may include a thesaurus (508). One skilled in the art of data processing will understand that there are many other example “documents” that may be used for the document-term matrix, and many types of example corpuses, other than a thesaurus, that may be used for the corpus, with departing from the spirit of the discussion herein.

For example, the document-term matrix may include one or more of matrix rows of elements that represent groups of terms that are included in thesaurus entries, or matrix columns of elements that represent groups of terms that are included in thesaurus entries (510).

According to an example embodiment, modifying the plurality of elements of the document-term matrix may include determining that a first term in the corpus is related as an antonym to a second term in the corpus, assigning a positive polarity value to the first term for inclusion in the document-term matrix, and assigning a negative polarity value to the second term, relative to the positive polarity value of the first term, for inclusion in the document-term matrix (512), in the example of FIG. 5b. For example, the similarities may include similarity values between pairs of terms that are represented in the term representation matrix.

For example, generating the term representation matrix may include generating the term representation matrix based on an approximation of the document-term matrix with latent semantic analysis (514). For example, the term representation matrix may be of substantially lower rank than the document-term matrix (516).

For example, determining the similarities may include determining term similarities between pairs of terms included in the term representation matrix, based on one or more of generating a cosine score of corresponding column vectors included in the term representation matrix that correspond to respective terms included in the pairs of terms, or generating a cosine score of corresponding row vectors included in the term representation matrix that correspond to respective terms included in the pairs of terms (518).

A query term may be obtained (520), in the example of FIG. 5c. For example, the term acquisition component 162 may obtain the query term 164, as discussed above. An alternative representation for the query term may be determined, if the query term is not included in the term representation matrix (522). For example, the term substitution component 166 may determine a substitute representation 168 for the query term 164, as discussed above.

For example, the alternative representation may be determined based on one or more of a morphological variation of the query term, or a stemmed version of the query term (524).

As another example, a query term may be obtained (526). An alternative representation for the query term may be determined, if the query term is not included in the term representation matrix (528). For example, the alternative representation may be determined based on generating a context vector representing the query term, based on a term collection that includes terms that are not included in the corpus (530).

For example, the query term may be embedded in a corpus space based on a context vector space associated with the context vector, based on one or more of a k-nearest neighbors determination, or linear regression (532).

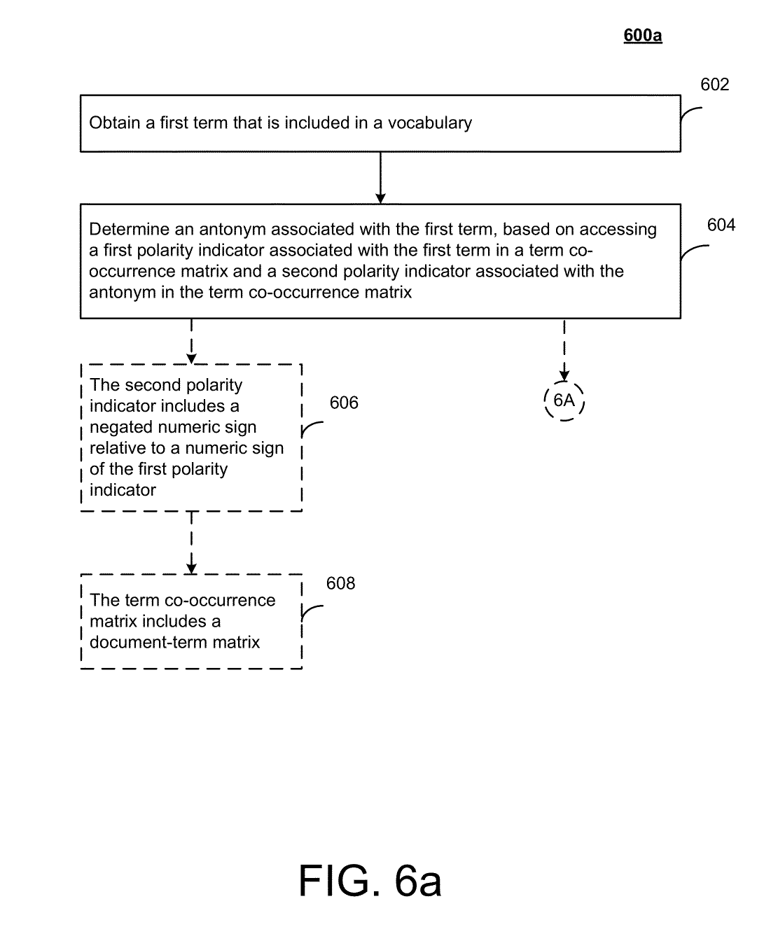

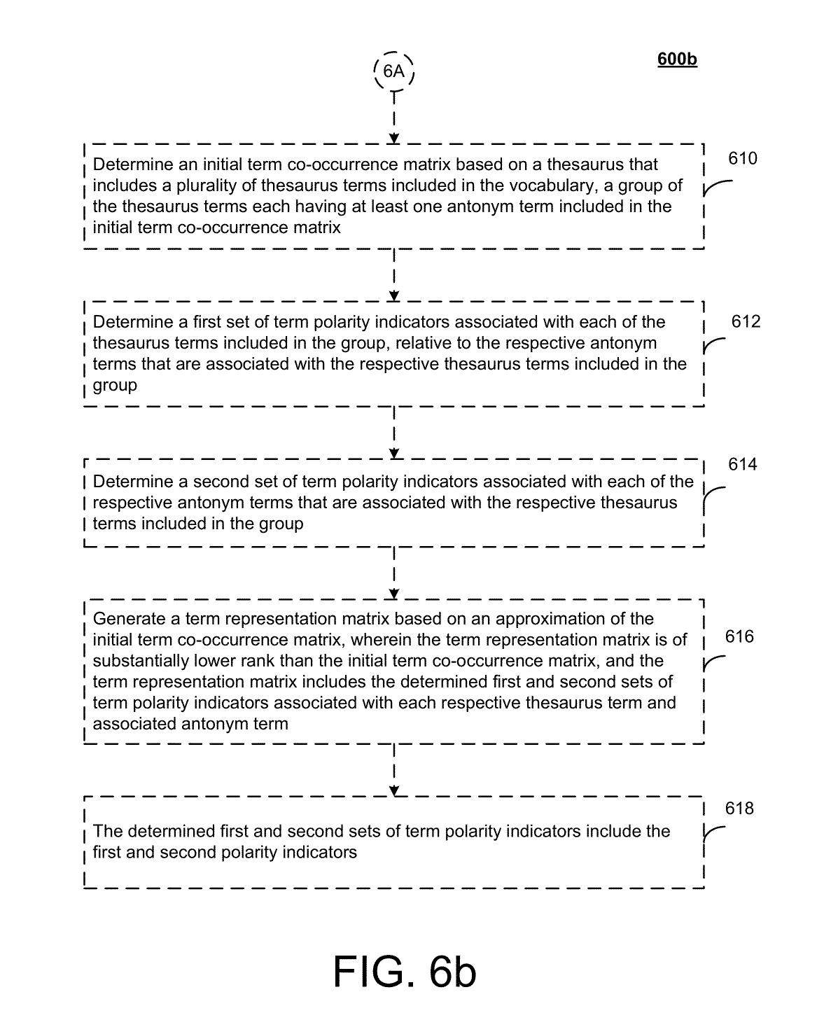

FIG. 6 is a flowchart illustrating example operations of the system of FIG. 1, according to example embodiments. In the example of FIG. 6a, a first term that is included in a vocabulary may be obtained (602).

An antonym associated with the first term may be determined, based on accessing a first polarity indicator associated with the first term in a term co-occurrence matrix and a second polarity indicator associated with the antonym in the term co-occurrence matrix (604).

For example, the second polarity indicator may include a negated numeric sign relative to a numeric sign of the first polarity indicator (606). For example, the term co-occurrence matrix may include a document-term matrix (608).

An initial term co-occurrence matrix may be determined based on a thesaurus that includes a plurality of thesaurus terms included in the vocabulary, a group of the thesaurus terms each having at least one antonym term included in the initial term co-occurrence matrix (610), in the example of FIG. 6b. A first set of term polarity indicators associated with each of the thesaurus terms included in the group, relative to the respective antonym terms that are associated with the respective thesaurus terms included in the group, may be determined (612). A second set of term polarity indicators associated with each of the respective antonym terms that are associated with the respective thesaurus terms included in the group may be determined (614).

A term representation matrix may be generated based on an approximation of the initial term co-occurrence matrix, wherein the term co-occurrence matrix is of substantially lower rank than the initial term co-occurrence matrix, and the term co-occurrence matrix includes the determined first and second sets of term polarity indicators associated with each respective thesaurus term and associated antonym term (616). The determined first and second sets of term polarity indicators may include the first and second polarity indicators (618).

One skilled in the art of data processing will understand that there are many ways of performing semantic analysis, without departing from the spirit of the discussion herein.

Customer privacy and confidentiality have been ongoing considerations in data processing environments for many years. Thus, example techniques for determining synonym-antonym polarity in term vectors may use user input and/or data provided by users who have provided permission via one or more subscription agreements (e.g., “Terms of Service” (TOS) agreements) with associated applications or services associated with semantic analysis. For example, users may provide consent to have their input/data transmitted and stored on devices, though it may be explicitly indicated (e.g., via a user accepted text agreement) that each party may control how transmission and/or storage occurs, and what level or duration of storage may be maintained, if any.

Implementations of the various techniques described herein may be implemented in digital electronic circuitry, or in computer hardware, firmware, software, or in combinations of them (e.g., an apparatus configured to execute instructions to perform various functionality). Implementations may be implemented as a computer program embodied in a propagated signal or, alternatively, as a computer program product, i.e., a computer program tangibly embodied in an information carrier, e.g., in a machine usable or machine readable storage device (e.g., a magnetic or digital medium such as a Universal Serial Bus (USB) storage device, a tape, hard disk drive, compact disk, digital video disk (DVD), etc.), for execution by, or to control the operation of, data processing apparatus, e.g., a programmable processor, a computer, or multiple computers. A computer program, such as the computer program(s) described above, can be written in any form of programming language, including compiled, interpreted, or machine languages, and can be deployed in any form, including as a stand-alone program or as a module, component, subroutine, or other unit suitable for use in a computing environment. The computer program may be tangibly embodied as executable code (e.g., executable instructions) on a machine usable or machine readable storage device (e.g., a computer-readable medium). A computer program that might implement the techniques discussed above may be deployed to be executed on one computer or on multiple computers at one site or distributed across multiple sites and interconnected by a communication network.

Method steps may be performed by one or more programmable processors executing a computer program to perform functions by operating on input data and generating output. The one or more programmable processors may execute instructions in parallel, and/or may be arranged in a distributed configuration for distributed processing. Example functionality discussed herein may also be performed by, and an apparatus may be implemented, at least in part, as one or more hardware logic components. For example, and without limitation, illustrative types of hardware logic components that may be used may include Field-programmable Gate Arrays (FPGAs), Program-specific Integrated Circuits (ASICs), Program-specific Standard Products (ASSPs), System-on-a-chip systems (SOCs), Complex Programmable Logic Devices (CPLDs), etc.

Processors suitable for the execution of a computer program include, by way of example, both general and special purpose microprocessors, and any one or more processors of any kind of digital computer. Generally, a processor will receive instructions and data from a read only memory or a random access memory or both. Elements of a computer may include at least one processor for executing instructions and one or more memory devices for storing instructions and data. Generally, a computer also may include, or be operatively coupled to receive data from or transfer data to, or both, one or more mass storage devices for storing data, e.g., magnetic, magneto optical disks, or optical disks. Information carriers suitable for embodying computer program instructions and data include all forms of nonvolatile memory, including by way of example semiconductor memory devices, e.g., EPROM, EEPROM, and flash memory devices; magnetic disks, e.g., internal hard disks or removable disks; magneto optical disks; and CD ROM and DVD-ROM disks. The processor and the memory may be supplemented by, or incorporated in special purpose logic circuitry.

To provide for interaction with a user, implementations may be implemented on a computer having a display device, e.g., a cathode ray tube (CRT), liquid crystal display (LCD), or plasma monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback. For example, output may be provided via any form of sensory output, including (but not limited to) visual output (e.g., visual gestures, video output), audio output (e.g., voice, device sounds), tactile output (e.g., touch, device movement), temperature, odor, etc.

Further, input from the user can be received in any form, including acoustic, speech, or tactile input. For example, input may be received from the user via any form of sensory input, including (but not limited to) visual input (e.g., gestures, video input), audio input (e.g., voice, device sounds), tactile input (e.g., touch, device movement), temperature, odor, etc.

Further, a natural user interface (NUI) may be used to interface with a user. In this context, a “NUI” may refer to any interface technology that enables a user to interact with a device in a “natural” manner, free from artificial constraints imposed by input devices such as mice, keyboards, remote controls, and the like.

Examples of NUI techniques may include those relying on speech recognition, touch and stylus recognition, gesture recognition both on a screen and adjacent to the screen, air gestures, head and eye tracking, voice and speech, vision, touch, gestures, and machine intelligence. Example NUI technologies may include, but are not limited to, touch sensitive displays, voice and speech recognition, intention and goal understanding, motion gesture detection using depth cameras (e.g., stereoscopic camera systems, infrared camera systems, RGB (red, green, blue) camera systems and combinations of these), motion gesture detection using accelerometers/gyroscopes, facial recognition, 3D displays, head, eye, and gaze tracking, immersive augmented reality and virtual reality systems, all of which may provide a more natural interface, and technologies for sensing brain activity using electric field sensing electrodes (e.g., electroencephalography (EEG) and related techniques).

Implementations may be implemented in a computing system that includes a back end component, e.g., as a data server, or that includes a middleware component, e.g., an application server, or that includes a front end component, e.g., a client computer having a graphical user interface or a Web browser through which a user can interact with an implementation, or any combination of such back end, middleware, or front end components. Components may be interconnected by any form or medium of digital data communication, e.g., a communication network. Examples of communication networks include a local area network (LAN) and a wide area network (WAN), e.g., the Internet.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims. While certain features of the described implementations have been illustrated as described herein, many modifications, substitutions, changes and equivalents will now occur to those skilled in the art. It is, therefore, to be understood that the appended claims are intended to cover all such modifications and changes as fall within the scope of the embodiments.

What is claimed is:

1. A system comprising:
a term relationship manager tangibly embodied via executable instructions stored on a computer-readable storage medium, the term relationship manager including:
an initial model generator configured to generate an initial document-term matrix based on a thesaurus;
a term representation generator configured to generate a term representation matrix based on modifying a plurality of elements of the initial document-term matrix based on antonym information associated with the plurality of elements of the initial document-term matrix, based on latent semantic analysis.

2. The system of claim 1, further comprising:
a polarity inducing component configured to determine polarity indicators associated with a group of indicated terms included in the initial document-term matrix, each of the indicated terms having an associated set of synonym terms representing synonyms to the respective associated indicated term, and an associated set of antonym terms representing antonyms to the respective associated indicated term, wherein the determined polarity indicators include:
a first set of term polarity indicators assigned to the indicated terms and their respective associated set of synonym terms, and
a second set of term polarity indicators assigned to each respective set of antonym terms associated with each respective indicated term,
wherein the first set of term polarity indicators represent a synonymy polarity that is opposite to an antonymy polarity represented by the second set of term polarity indicators.

3. The system of claim Error! Reference source not found., wherein:
each of the term polarity indicators in the second set of term polarity indicators includes a negated numeric sign relative to a numeric sign of the term polarity indicators in the first set of term polarity indicators.

4. The system of claim 1, wherein:
the term representation generator is configured to generate the term representation matrix based on an approximation of the initial document-term matrix based on latent semantic analysis, wherein
the term representation matrix is of substantially lower rank than the initial document-term matrix.

5. The system of claim 4, wherein:
the term representation generator is configured to generate the term representation matrix based on one or more of:
an approximation with singular value decomposition, or
an approximation with eigen-decomposition on a corresponding covariance matrix.

6. The system of claim 1, further comprising:
a term similarity determination component configured to determine, via a device processor, term similarities based on a plurality of elements of the term representation matrix.

7. The system of claim 6, wherein:
the term similarity determination component is configured to determine a measure of similarity between pairs of terms included in the thesaurus based on one or more of:
generating a cosine score of corresponding column vectors included in the term representation matrix that correspond to respective terms included in the pairs, or
generating a cosine score of corresponding row vectors included in the term representation matrix that correspond to respective terms included in the pairs.

8. The system of claim 1, wherein:
the initial model generator is configured to generate the initial document-term matrix based on determining respective weight values for each element of the initial document-term matrix, based on one or more of:
a term-frequency function, or
a term frequency times inverse document frequency (TF-IDF) function.

9. The system of claim 1, further comprising:
a term acquisition component configured to obtain a query term; and
a term substitution component configured to determine a substitute representation for the query term, if the query term is not included in the thesaurus, wherein the term substitution component determines the substitute representation for the query term based on one or more of:
a morphological variation of the query term,
a stemmed version of the query term, or
a context vector representing the query term, wherein the context vector is generated based on a corpus that includes terms that are not included in the thesaurus.

10. A method comprising:
generating a document-term matrix based on a corpus;
generating, via a device processor, a term representation matrix based on modifying a plurality of elements of the document-term matrix based on antonym information included in the corpus; and
determining similarities based on a plurality of elements of the term representation matrix.

11. The method of claim 10, wherein:
the corpus includes a thesaurus, wherein
the document-term matrix includes one or more of:
matrix rows of elements that represent groups of terms that are included in thesaurus entries, or
matrix columns of elements that represent groups of terms that are included in thesaurus entries.

12. The method of claim 10 wherein:
modifying the plurality of elements of the document-term matrix includes:
determining that a first term in the corpus is related as an antonym to a second term in the corpus;
assigning a positive polarity value to the first term for inclusion in the document-term matrix; and
assigning a negative polarity value to the second term, relative to the positive polarity value of the first term, for inclusion in the document-term matrix, wherein
the similarities include similarity values between pairs of terms that are represented in the term representation matrix.

13. The method of claim 10 wherein:
generating the term representation matrix includes generating the term representation matrix based on an approximation of the document-term matrix with latent semantic analysis, wherein the term representation matrix is of substantially lower rank than the document-term matrix.

14. The method of claim 10 wherein:
determining the similarities includes determining term similarities between pairs of terms included in the term representation matrix, based on one or more of:
generating a cosine score of corresponding column vectors included in the term representation matrix that correspond to respective terms included in the pairs of terms, or
generating a cosine score of corresponding row vectors included in the term representation matrix that correspond to respective terms included in the pairs of terms.

15. The method of claim 10, further comprising:
obtaining a query term; and
determining an alternative representation for the query term, if the query term is not included in the term representation matrix, wherein the alternative representation is determined based on one or more of:
a morphological variation of the query term, or
a stemmed version of the query term.

16. The method of claim 10, further comprising:
obtaining a query term; and
determining an alternative representation for the query term, if the query term is not included in the term representation matrix, wherein the alternative representation is determined based on generating a context vector representing the query term, based on a term collection that includes terms that are not included in the corpus.

17. The method of claim 16, further comprising:
embedding the query term in a corpus space based on a context vector space associated with the context vector, based on one or more of:
a k-nearest neighbors determination, or
linear regression.

18. A computer program product tangibly embodied on a computer-readable storage medium and including executable code that causes at least one data processing apparatus to:
obtain a first term that is included in a vocabulary;
determine an antonym associated with the first term, based on accessing a first polarity indicator associated with the first term in a term co-occurrence matrix and a second polarity indicator associated with the antonym in the term co-occurrence matrix.

19. The computer program product of claim 18, wherein:
the second polarity indicator includes a negated numeric sign relative to a numeric sign of the first polarity indicator, wherein
the term co-occurrence matrix includes a document-term matrix.

20. The computer program product of claim 18, wherein the executable code is configured to cause the at least one data processing apparatus to:
determine an initial term co-occurrence matrix based on a thesaurus that includes a plurality of thesaurus terms included in the vocabulary, a group of the thesaurus terms each having at least one antonym term included in the initial term co-occurrence matrix;
determine a first set of term polarity indicators associated with each of the thesaurus terms included in the group, relative to the respective antonym terms that are associated with the respective thesaurus terms included in the group;
determine a second set of term polarity indicators associated with each of the respective antonym terms that are associated with the respective thesaurus terms included in the group; and
generate a term representation matrix based on an approximation of the initial term co-occurrence matrix, wherein the term representation matrix is of substantially lower rank than the initial term co-occurrence matrix, and the term representation matrix includes the determined first and second sets of term polarity indicators associated with each respective thesaurus term and associated antonym term, wherein
the determined first and second sets of term polarity indicators include the first and second polarity indicators.
